(19) United States
(12) Patent Application Publication
(10) Pub. No.: US 2026/0011934 A1
(43) Pub. Date: Jan. 8, 2026

(54) Wire Clamping Assembly and Connector Arrangement

(71) Applicants: TE Connectivity Nederland B.V., TV's-Hertogenbosch (NL); TE Connectivity India Private Limited, Bangalore (IN); TE Connectivity Solutions GmbH, Schaffhausen (CH); ERNI Deustschland GmbH, Adelberg (DE)

(72) Inventors: Mohamed ABOULKASSEM, Schaffhausen (CH); Adarsh Krishnan, Bangalore (IN); Ludwig Lange, 's-Hertogenbosch (NL); Fabian Kristmann, Adelberg (DE); Ankith Ramesh, Bangalore (IN); Gururaj Settru, Bangalore (IN)

(73) Assignees: TE Connectivity Nederland B.V., TV's-Hertogenbosch (NL); TE Connectivity India Private Limited, Bangalore (IN); TE Connectivity Solutions GmbH, Schaffhausen (CH); ERNI Deustschland GmbH, Adelberg (DE)

(21) Appl. No.: 19/257,558

(22) Filed: Jul. 2, 2025

(30) Foreign Application Priority Data
Jul. 3, 2024 (EP) 24186339.8

(51) Int. Cl. H01R 4/48

(52) U.S. Cl. CPC H01R 4/48

(57) ABSTRACT

A wire clamping assembly and a connector arrangement for automatically contacting an electrical conductor upon insertion of the electrical conductor into the wire clamping assembly. The wire clamping assembly includes a clamping spring, a trigger, and a latch. The latch engages the clamping spring in a preloaded position of the clamping spring. The trigger is coupled to the latch and configured to disengage the latch when the trigger is operated, thereby releasing the clamping spring. The released clamping spring being configured to clamp the inserted electrical conductor in a clamping position of the clamping spring. The trigger is configured to be operated by the electrical conductor upon insertion of the electrical conductor into the wire clamping assembly. The trigger and the clamping spring are two separate elements.

### CROSS-REFERENCE TO RELATED APPLICATION

This application claims the benefit of European Patent Application No. 24186339.8 filed on Jul. 3, 2024 in the European Patent Office, which is hereby incorporated by reference in its entirety.

### BACKGROUND OF THE INVENTION

The invention relates to a wire clamping assembly for automatically clamping an electrical conductor, such as a lead wire or a pin, upon insertion of the electrical conductor into the wire clamping assembly. The invention further relates to a connector arrangement comprising a plurality of said wire clamping assemblies.

Assemblies for automatically clamping electrical conductors are crucial in industries requiring reliable and cost-effective connections. They are easy to use because an electrical connection can be established simply by inserting the conductor into the wire clamping assembly.

Such assemblies excel in adaptability, accommodating various conductor types and sizes to enhance installation flexibility while minimising costs. These assemblies also streamline processes, reduce assembly times, and integrate seamlessly into automation. They are designed to withstand vibrations and mechanical stresses for long-term reliability. Stability and safety are prioritised, mitigating risks of arcing, overheating, and hazards to meet stringent safety standards. These features make automatic assemblies indispensable across automotive, electronics, telecommunications, and power industries, enhancing productivity and reliability in various applications. However, there is a continued need for innovative solutions that streamline electrical connection processes while maintaining high levels of performance, reliability, and cost-effectiveness.

### SUMMARY OF THE INVENTION

The object of the invention is to therefore provide an assembly for automatically contacting electrical conductors that is able to accommodate various conductor types and sizes, offering a standardised yet flexible and cost-effective solution for diverse applications.

This object is solved by providing the aforementioned wire clamping assembly, comprising a clamping spring, a trigger, and a latch, wherein the latch engages the clamping spring in a preloaded position of the clamping spring; wherein the trigger is coupled to the latch and configured to disengage the latch when the trigger is operated, thereby releasing the clamping spring, the released clamping spring being configured to clamp the inserted electrical conductor in a clamping position of the clamping spring; wherein the trigger is configured to be operated by the electrical conductor upon insertion of the electrical conductor into the assembly; and wherein the trigger and the clamping spring are two separate elements.

The above wire clamping assembly is easy to use. It is cost-efficient as it allows to accommodate a wide variety of different conductor types and sizes. It does so by eliminating the need for a tool to contact the electrical conductor and by automatically and quickly clamping the electrical conductor with high clamping forces once the electrical conductor is inserted into the wire clamping assembly.

Because the clamping spring and the trigger are two separate elements, they can be easily configured with different stiffnesses. Thus, the force generated by the clamping spring, i.e. the force for contacting and fixating the conductor can be designed independently of the force that is needed to actuate the trigger. Thus, the wire clamping assembly may be designed to require relatively low insertion forces to operate the trigger, or to provide a specific insertion force. Once the electrical conductor is inserted with a low insertion force, it operates the trigger, which releases the clamping spring, which in turn clamps the electrical conductor with a clamping force.

The wire clamping assembly ensures flexible operation as it is capable of contacting a wide range of electrical conductors, including solid, stranded and/or ferrule-equipped conductors, such as cables, wires or cable strands, as well as those without a plastic collar. In one example, a single assembly can accommodate electrical conductors of various sizes, from 18 AWG to 6 AWG.

Further improvements may be made by any one of the following features, which are independent from one another with respect to their respective technical effects and can be combined with each other in any combination.

For example, the trigger may comprise a trigger spring and, in the clamping position of the clamping spring, said trigger spring may be deflected from its position at which the latch engages the clamping spring. The trigger spring may be configured to be operated directly or indirectly by the electrical conductor when the electrical conductor is inserted into the wire clamping assembly in an insertion direction. In such a situation, the trigger spring imparts a force, directly or indirectly, onto the inserted electrical conductor, the force being directed against the insertion direction. The force generated by the trigger spring and acting on the conductor should be smaller than the holding force exerted by the clamping force, wherein the holding force fixates the clamped conductor. The force generated by the trigger spring against the insertion direction facilitates removal of the electrical conductor once it is released from the clamping spring, as the electrical conductor is pushed out of the wire clamping assembly.

The separation of the trigger spring and the clamping spring makes the above assembly more versatile than e.g. known assemblies where the clamping spring and the trigger spring are two different parts of a monolithic spring body. Here, different stiffnesses of the clamping spring and the trigger spring require elaborate changes in the form and cross-section of the clamping spring and/or the trigger spring.

Additionally, or alternatively, the wire clamping assembly may further comprise a pivoting element and, in the clamping position of the clamping spring, said pivoting element may be pivoted out of its position at which the latch engages the clamping spring. The pivoting element may also be operated by the electrical conductor when the electrical conductor is inserted into the wire clamping assembly in the insertion direction.

The pivoting element may comprise a trigger part. The trigger part may be a rigid body. The stiffness of the pivoting element or the stiffness of the pivoting element may be higher than the stiffness of the trigger spring and/or the stiffness of the rigid body. The pivoting element or the rigid body may be essentially more rigid than the trigger spring and the clamping spring.

The latch may comprise a trigger component that is stationary relative to the trigger. As an alternative, the trigger component may be located on the trigger or may be monolithically combined with the trigger. The trigger component of the latch may engage the clamping spring in the preloaded position of the clamping spring directly or indirectly via a form fit. The trigger component may be arranged on the trigger spring or on the pivoting element.

Additionally, or alternatively to the trigger component, the latch may comprise a clamping-spring component that is stationary relative to the clamping spring. As an alternative, the clamping-spring component may be located on the clamping spring or may be monolithically combined with the clamping spring.

When the latch comprises both a trigger component and a clamping-spring component, the trigger component of the latch and the clamping-spring component of the latch may be engaged in a form fit when the clamping spring is in the preloaded position. In this embodiment, the engagement between the trigger component of the latch and the clamping-spring component of the latch is maintained in the preloaded position of the clamping spring regardless of the direction of the forces generated by the trigger spring and the clamping spring. When the trigger is actuated by the electrical conductor, the trigger component of the latch is moved away from the clamping-spring component of the latch, thereby releasing the latch and thus the clamping spring, which releases and clamps the electrical conductor.

In an exemplary embodiment, the trigger component and the clamping-spring component of the latch both comprise or are protrusions on the trigger and the clamping spring, respectively. Alternatively, either (but not both) the trigger component or the clamping-spring component of the latch comprises or is a recess, and the respective other of the trigger component or the clamping spring component is a protrusion that is received in the recess when the clamping spring is in the preloaded position of the clamping spring.

According to another aspect of the invention, the wire clamping assembly may comprise a reset device configured to move the clamping spring from its clamping position towards the direction of its preloaded position. The reset device may move the clamping spring towards a position where the latch engages the clamping spring and the clamping spring is held in its preloaded position. When the clamping spring is moved away from the clamping position, the conductor may be moved away from the wire clamping assembly against the insertion direction. The reset device may be configured to be actuated, in particular manually operated, from outside the wire clamping assembly. It allows removing the electrical conductor from the wire clamping assembly and re-arranging the wire clamping assembly and specifically the trigger for a new insertion of an electrical conductor.

In one embodiment, the latch is configured to automatically engage the clamping spring when the reset device moves the clamping spring out of its clamping position towards the trigger and the conductor is removed from the wire clamping assembly. In this case, the trigger may be moved by the trigger spring towards a position where the latch engages the clamping spring.

The reset device may comprise a lever, said lever having a rest position, wherein it remains during normal operation, and is pivotable from said rest position to a release position in which it contacts the clamping spring in the clamping position of the clamping spring. The reset device, in particular the lever, may be configured to also contact the clamping spring in the preloaded position. Thus, the reset device, in particular the lever, may be configured to push the clamping spring from the clamping position into the preloaded position. The lever may be located outside the housing. It may cover or form one side of the assembly.

A lock may be provided which locks the lever in the rest position relative to the housing. The lock may require a predetermined minimum force to move the lever out of the rest position. Thus, the lever cannot be actuated inadvertently. The lock may be configured as two protrusions extending out from each lateral side of the lever that interlock with the housing, for example with locking elements configured as recesses in the housing. The protrusions may be attached to a flexible or elastically deformable part of the lever which may be deformable in lateral direction to release the locking of the lever when deformed, the lateral direction being perpendicular to the insertion direction.

According to another aspect, the wire clamping assembly may further comprise a housing, wherein the clamping spring, the trigger, and the latch are arranged or mounted within the housing. The clamping spring and the trigger may both extend out of the housing in a lengthwise direction along the length of the clamping spring and/or trigger, perpendicular to the insertion direction and the lateral direction and may be longer than the housing in the lengthwise direction. The housing may comprise a wall in the lateral direction and may be open on at least one side. Said housing may comprise an insertion opening for the insertion of the electrical conductor in the insertion direction and a conductor receptacle for receiving the electrical conductor. The conductor receptacle is connected to the outside of the wire clamping assembly by the insertion opening and surrounded at least partly by the housing. At least a section of the trigger is arranged beyond the insertion opening in the insertion direction so that the electrical conductor can contact and operate the trigger when the electrical conductor is inserted into the wire clamping assembly. In other words, the at least part of the trigger is arranged adjacent to the conductor receptacle in the insertion direction.

The housing may be made from a stamped and formed metal sheet, a moulded resin, or a multi-component mould including metal and/or resin. Furthermore, the housing may be partly open in a lateral direction and may be completely open on at most one side.

The clamping spring may be an integral part of the housing, which reduces the manufacturing steps. Alternatively, it may be configured to be received or mounted in the housing. The clamping spring may comprise a stationary straight section that is stationary relative to the housing and a clamping section that is not stationary relative to the housing. The stationary section and the clamping section may be joined by an intermediate section. The intermediate section may be located between and forms a transition between the clamping section and the stationary section. The intermediate section may be a clamping force generating part of the clamping spring, e.g. a flexible section, e.g. a spring section, connecting the stationary section and the clamping section. The intermediate section may comprise a bent section, which may be curved, at least in sections or in its entirety, or which may comprise one more straight parts. The bent section may extend out of the housing.

In the clamping position, the electrical conductor may be clamped between the clamping spring on one side and the housing on the other side. The housing may be electrically conductive, where the electrical conductor is clamped. Similar to the clamping spring, part of the trigger, e.g. the clamping spring, may be an integral part of the housing. In the embodiments where the trigger comprises a pivoting element, the pivoting element comprising or consisting of a rigid body, said rigid body is configured to pivot about a point that is stationary relative to the housing. The pivoting element may be held at this point by an axis, which may be part of the housing or the pivoting element.

The reset device or the lever may be mounted to the housing and may be pivotable around a pivot point that is stationary relative to the housing. Furthermore, the housing may provide a stopper for the reset device, in particular the lever, limiting the travel of the reset device in the direction of the clamping spring and the clamping position.

According to another aspect of the invention, the wire clamping assembly may comprise a contact rail that extends out of the housing in the insertion direction and is configured to contact the electrical conductor, e.g. when the electrical conductor is inserted into the wire clamping assembly and clamped by the clamping spring. The contact rail may be connected to a mating connector or to a printed circuit board. The contact rail may consist of or comprise a metal sheet strip, the wide face of the metal strip being exposed to contact the electrical conductor and e.g. having a width that is larger than the width of the clamping spring. Accordingly, the clamping spring may be configured to push the electrical conductor against the contact rail in the clamping position of the clamping spring.

The housing may comprise a rail receptacle, e.g. a shaft or slot which may be open in the insertion direction or the lateral direction, configured to receive the contact rail along the insertion direction. The rail receptacle may be configured as one groove on each side of the contact rail along the insertion direction. The length of the contact rail may be greater that the length of the conductor receptacle in the insertion direction, so that the contact rail can contact the electrical conductor when the electrical conductor is inserted into the wire clamping assembly and, at the same time, the contact rail can contact an external electrical lead that may be connected to the wire clamping assembly. In one embodiment, the contact rail may extend out of the housing.

The housing may be configured as a cage, i.e. a confining metal structure which guides the movement of the conductor, the trigger spring and/or the clamping spring in a plane parallel to the insertion direction. The housing or cage may be closed and comprise two lateral walls which are connected by a wall parallel to the straight stationary section of the clamping spring and a wall opposite the straight section, which enhances the structural integrity of the wire clamping assembly.

According to another aspect of the invention, a connector arrangement may be provided, which comprises a plurality of wire clamping assemblies in any of the configurations described above.

The connector arrangement may further comprise an outer housing that may be made of a resin or plastic material. The outer housing may comprise a plurality of receiving receptacles, wherein each wire clamping assembly of the plurality of wire clamping assemblies may be configured to be received in a receiving receptacle of the plurality of receiving receptacles and each wire clamping assembly of the plurality of wire clamping assemblies may be received in a different receiving receptacle. In this way, each wire clamping assembly of the plurality of wire clamping assemblies is electrically insulated from all other wire clamping assemblies of the plurality of wire clamping assemblies. The plurality of receiving receptacles may be arranged in one or more rows.

The reset device or the lever may be mounted on the outer housing and/or one part of the reset device or the lever may be held between the inner housing of a wire clamping assembly and the outer housing, so that the reset device possesses only the degrees of freedom to move the clamping spring from the clamping position of the clamping spring in the direction of the preloaded position of the clamping spring.

The housing of each wire clamping assembly of the plurality of wire clamping assemblies comprises attachment means to attach the housing of another adjacent wire clamping assembly of the plurality of wire clamping assemblies. For example, the sides of the housing that are facing perpendicular to the lateral direction may be provided with respectively complementary attachment means, such as dovetail joints that extend along the insertion direction. The connector arrangement may be provided in different embodiments, each embodiment having an outer housing with a different number of receiving receptacles. In another embodiment, the connector arrangement may comprise an inner housing with slots and receiving receptacles for multiple wire clamping assemblies. The inner housing may be designed as an integral part with a set number of slots and receiving receptacles for a set number of wire clamping assemblies, which is particularly beneficial for mass production for a particular use case and for saving assembly time.

The wire clamping assembly may then be inserted along the insertion direction, as an alternative to the lateral assembly of the embodiment described above. The wire clamping assembly may comprise the pre-assembly of the clamping spring, which is integral with the housing, and the mounted trigger.

### BRIEF DESCRIPTION OF THE DRAWINGS

In the following, exemplary embodiments are described with reference to the figures. In the figures, the same reference numerals are used for elements that correspond to one another in terms of their function and/or structure. As described above, an element of an embodiment can be omitted if its technical effects is not needed for a particular application, and vice versa: an element that is not part of a specific embodiment may be added if its technical effect is advantageous in a specific application. In the figures:

FIG. 1 shows a schematic lateral view of a wire clamping assembly in a preloaded position;

FIG. 2 shows a schematic lateral view of the wire clamping assembly of FIG. 1 in a clamping position;

FIG. 3 shows a schematic lateral cross-sectional view of another wire clamping assembly in a preloaded position;

FIG. 4 shows a schematic lateral cross-sectional view of the embodiment of FIG. 3 in a clamping position;

FIG. 5 shows a schematic lateral cross-sectional view of the embodiment of FIG. 3 in a clamping position;

FIG. 6 shows a schematic lateral view of an embodiment of the wire clamping assembly in a preloaded position;

FIG. 7 shows a schematic lateral view of the embodiment of FIG. 6 in a clamping position;

FIG. 8 shows a schematic lateral view of the embodiment of FIG. 6 with release of the clamping spring;

FIG. 9 shows a schematic perspective view of a connector arrangement;

FIG. 10 shows a schematic exploded view of the connector arrangement of FIG. 6; and

FIG. 11 shows a schematic exploded view of another embodiment of the connector arrangement.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

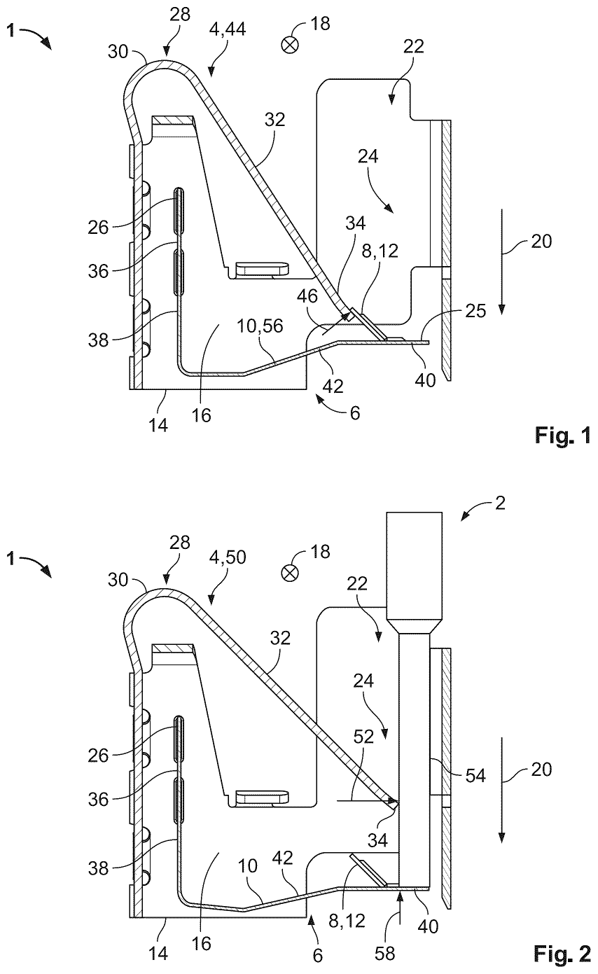

A first embodiment of a wire clamping assembly 1 for contacting an electrical conductor 2 is described with reference to FIGS. 1 and 2. The wire clamping assembly 1 comprises a clamping spring 4, a trigger 6, and a latch 8 that is coupled to the trigger 6. The trigger 6 and the clamping spring 4 are two separate elements, i.e. two physically distinct bodies that may be made of different materials and/or of elements having different material thickness. The trigger 6 may comprise a trigger spring 10 that may be a separate or an integral part of the trigger 6. A stiffness of the clamping spring 4 may be different, in particular larger, than a stiffness of the trigger 6, especially the trigger spring 10. The latch 8 may comprise a trigger component 12 that is monolithically combined with the trigger 6. The trigger component 12 may e.g. simply be a tab that protrudes from the rest of the trigger 6 or the trigger spring 10 towards the clamping spring 4 and is configured to engage the clamping spring 4.

The wire clamping assembly 1 according to the first embodiment may further comprise a housing 14. The clamping spring 4, the trigger 6, and the latch 8 may be arranged or mounted in the housing 14. The housing 14 may provide a wall 16 in a lateral direction 18, namely, it may surround the clamping spring 4, the trigger 6, and the latch 8 at least partially in the lateral direction 18. The housing 14 may be completely open on one side, e.g. in a direction opposite the lateral direction 18. The housing 14 may be configured as a cage, i.e. a confining structure in particular made of metal, which guides the movement of an electrical conductor 2, the trigger spring 8 and/or the clamping spring 4 in a plane parallel to an insertion direction 20, as can be seen in FIGS. 6 to 8. The insertion direction 20 is perpendicular to the lateral direction 18.

The housing 14 comprises an insertion opening 22 for the insertion of the electrical conductor 2 in the insertion direction 20 and a conductor receptacle 24 for receiving the electrical conductor 2. A triggering section 25 of the trigger 6 is arranged aligned with and beyond the insertion opening 22 in the insertion direction 20 so that the electrical conductor 2, specifically its end, can contact and operate the trigger 6 when the electrical conductor 2 is inserted into the wire clamping assembly 1. In other words, the triggering section 25 of the trigger 6 is arranged in the conductor receptacle 24. The trigger spring 10 braces the triggering section 25 against the insertion direction 20.

In the first embodiment, the clamping spring 4 is integral with the housing 14. The clamping spring 4 may comprise a stationary section 26 that is stationary relative to the housing 14 and may be straight. The stationary section 26 is connected to the housing 14. The clamping spring 4, in particular the stationary section 26 thereof may be a monolithic part of the housing 14. The clamping spring 4 may further comprise a clamping section 32 that is not held stationary relative to the housing 14. The stationary section 26 and the clamping section 32 may form two legs of the clamping spring 4 joined by an intermediate section section 28. The intermediate section 28 is located between the clamping section 32 and the stationary section 26 and forms a transition between the sections 32 and 26. The angle between the two legs and facing the trigger 6 may be less than about 90°, e.g. between about 80° and 50°. The intermediate section 28 may comprise a bent section 30, which may be curved, at least in sections or in its entirety, or which may comprise one or more straight parts. The bent section 30 may extend out of the housing 14 and the clamping section 32 has a clamping end 34 configured to clamp the electrical conductor 2.

In another embodiment, the trigger spring 10 may be an element that is bodily separate from the housing 14, i.e a separate part. In such a case, the trigger spring 10 may be mounted to the housing 14. For example, the trigger spring 10 may be inserted into the housing 14, e.g. a slot or shaft of the housing, along the lateral direction 18 or along the insertion direction 20. The trigger spring 10 may be substantially L- or V-shaped. For example, an end 36 of a first leg 38 of the trigger spring 10 may be fixed to, in particular in, the housing 14, and an end 40 of the second leg 42 of the trigger spring 10 may be configured to protrude into the conductor receptacle 24. Thus, the trigger spring 10 is configured to be displaced by the electrical conductor 2 when the electrical conductor 2 is inserted into the wire clamping assembly 1, in particular into the conductor receptacle 24 in the insertion direction 20.

In FIG. 1, the latch 8 engages and holds the clamping spring 4 in a preloaded position 44 of the clamping spring 4 via a form fit. The latch 8 is formed by the clamping end 34 of the clamping spring 4 and the trigger component 12 of the trigger 6. In the preloaded position 44, the clamping spring 4 is held deflected and is thus under tension. The bias generated by the clamping spring 4 is directed into the conductor receptacle. In the preloaded position 44, the clamping spring 4 does not protrude or protrudes less into the conductor receptacle 24.

An elastic force 46 generated by the deflection of the clamping spring 4 in the preloaded position may be directed towards or into the latch 8. Thus, the deflected clamping spring 4 in the preloaded position 44 enforces the latched state of the latch 8. As can be seen, the latch 8 is formed by the free end of the clamping spring 4.

In the preloaded position 44, the trigger spring 10 is also deflected with respect to its rest position. This rest position is the position of the trigger spring 10, which the trigger spring would assume, when no external forces are acting on it. The elastic force 46 of the clamping spring 4 in the preloaded position 44 may be directed away from the rest position of the trigger spring 10, i.e. in the preloaded position, the forces generated by the trigger spring 10 and the clamping spring 4 oppose each other. In both cases, the trigger spring 10 is held in a deflected state by the elastic force 46 via the latch 8.

The trigger 6 is configured to be operated, in particular to be operated automatically, by the electrical conductor 2 upon insertion of the electrical conductor 2 into the wire clamping assembly 1 in the insertion direction 20. Specifically, when the electrical conductor 2 is moved into the conductor receptacle 24, its end will hit the trigger 6, in particular the triggering section 25, and move it in the insertion direction 20 against the action of the trigger spring 10. The trigger component 12 of the latch 8 is moved together with the trigger 6 out of engagement with the clamping spring 4. Thus, the latch 8 is released and the clamping spring 4 relaxes by moving against the electrical conductor 2 in the conductor receptacle 24. The release of the latch 8 induces the passage from the state of FIG. 1 to the state of FIG. 2, i.e. from the preloaded position 44 to a clamping position 50.

In the clamping position 50, the (now released) clamping spring 4 clamps the inserted electrical conductor 2. The clamping spring 4 is deflected less in the clamping position 50 than in the preloaded position 44, but is still not completely relaxed. The clamping spring 4 therefore exerts a clamping force 52 on the electrical conductor 2, holding the electrical conductor 2 fixed in a contact position 54 of the electrical conductor 2.

The clamping section 32 may be inclined relative to the insertion direction 20 extending into the insertion direction 20. Thus, if the clamped electrical conductor 2 is pulled out of the assembly 1 against the insertion direction 20, the clamping section 32, in particular at the clamping end 34 will also be moved somewhat against the insertion direction 20. Consequently, the clamping section 32 will be moved into a less inclined position relative to the insertion direction 20, thereby pressing the stationary section 26 against the housing 14 and the clamping section 32 against the electrical conductor 2. This will increase the force with which the electrical conductor 2 is clamped. Thus, the clamping of the electrical conductor 2 by the clamping spring 4 is self-reinforcing when pulling on the electrical conductor 2 in the clamping position 50.

In the clamping position 50, the trigger spring 10 is deflected from its position 56 at which the latch 8 engages the clamping spring 4. The deflection is held by the electrical conductor 2, which may directly push the trigger spring 10 in the insertion direction 20. Therefore, the trigger spring 10 also imparts a reaction force 58 onto the inserted electrical conductor 2 opposite the insertion direction 20. The reaction force 58 increases the force with which the electrical conductor 2 is clamped.

In a variant of the embodiment of FIGS. 1 and 2, the clamping spring 4 may be integral with the housing 14, e.g. be formed by bending the same metal sheet from which the housing 14 is made.

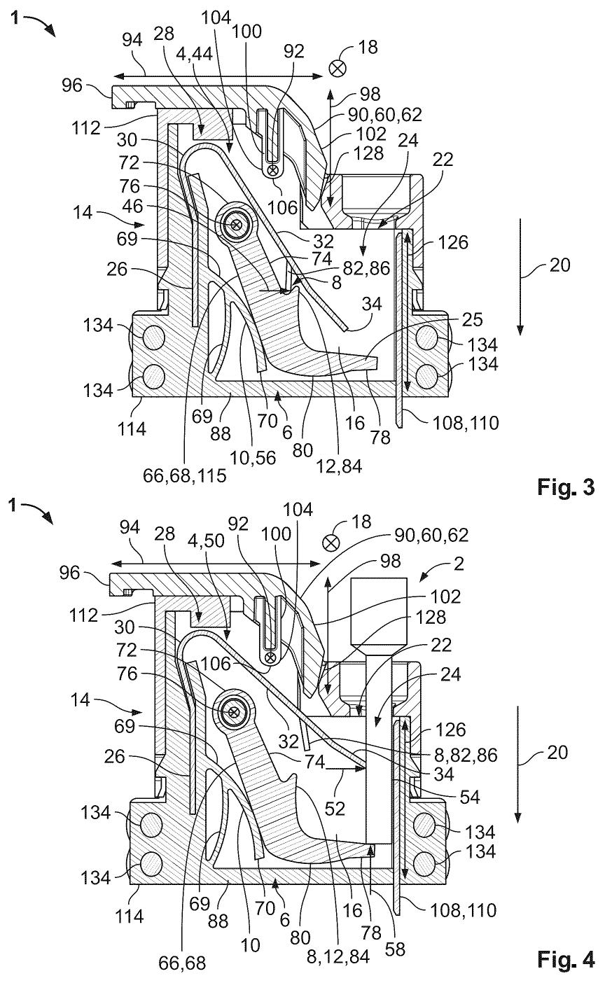

A second embodiment of the wire clamping assembly 1 is described with reference to FIGS. 3 to 5. Only the differences to the embodiment of FIGS. 1 and 2 are described.

The trigger 6 comprises the trigger spring 10 and a pivoting element 66. The pivoting element 66 may comprise or consist of a trigger part 68, which may be rigid or at least have a higher stiffness than the trigger spring 10. The trigger spring 10 may be integral with the housing 14. It may have a λ-shape, where two ends 69 of the trigger spring 10 are stationary relative to the housing 14 and a free end 70 of the trigger spring 10 may be in mechanical contact with the trigger part 68. The trigger spring 10 may be a monolithic part of the housing 14, which may e.g. be a moulded, in particular injection-moulded part. The trigger part 68 is configured to pivot around a pivoting axis 76, that may be formed by a protrusion of the housing 14 or by a stub of the trigger part 68. At the axis 76, the trigger part 68 may be clipped to the housing 14.

The trigger part 68 may be substantially L-shaped: the pivoting axis 76 may be located at an end 72 of a first leg 74 of the trigger part 68, whereas an end 78 of a second leg 80 of the trigger part 68 may be configured to be moved by the electrical conductor 2 when the electrical conductor 2 is inserted into the wire clamping assembly 1. An angle between the two legs 74, 80 may be larger than 90°, in particular at the side of the trigger part 68 pointing into the conductor receptacle 24.

The latch 8 comprises the trigger component 12 that is monolithically combined with the trigger 6 and a clamping-spring component 82 that is monolithically combined with the clamping spring 4. The two components 12, 82 are complementary to each other, meaning that the trigger component 12 of the latch 8 may engage the clamping-spring component 82 of the latch 8 to constitute a form fit in the preloaded position 44. Specifically, in this exemplary embodiment, the trigger component 12 and the clamping-spring component 82 of the latch 8 comprise a trigger protrusion 84 and a clamping-spring protrusion 86, respectively. The latch 8 may be located on the first leg 74 of the trigger part 68.

If the electrical conductor 2 is inserted into the housing 14 in the insertion direction 20, its end will, in the preloaded position 44, press against the triggering section 25 which is located at the end 78 of the trigger part 68 opposite the pivoting axis 76. The trigger part 68 is pivoted around the pivot axis 76 away from the clamping spring 4 by the electrical conductor 2 thereby releasing the latch 8 and the clamping spring 4.

According to the second embodiment, the housing 14 may provide a wall 16 in the lateral direction 18 as well as a bottom 88 in the insertion direction 20. The housing 14 may form a slot into which the clamping spring 4 is inserted in the lateral direction 18. Further, the trigger part 68 may also be mounted to the housing 14 from the lateral direction 18.

The wire clamping assembly 1 in any of the above embodiments may comprise a reset device 90. The reset device 90 is configured to move the clamping spring 4 out of the clamping position 50 towards the preloaded position 44 and to re-arm the trigger 6 by re-engaging the latch 8.

The reset device 90 may comprise a lever 60 that is held pivotably around a pivot axis 92 stationary relative to the housing 14. The lever 60 may substantially have an L- or F-shape: along its longer dimension 94, the lever 60 may have a free end 96 where the lever 60 may be actuated by a user or a machine. The free end 96 points away from the insertion opening 22.

Along its shorter dimension 98, the lever 60 may comprise a pivoting protrusion 100 and a pushing protrusion 102. The pivoting protrusion 100 is optional. It provides a pivot axis for the lever 60 at the required offset at its end 104. The lever 60 may comprise at its pivot axis a snub which is inserted into the housing 14 or may be clipped into a protrusion of the housing 14.

The pushing protrusion 102 protrudes towards the clamping spring 4. It may be rounded and is configured to push the clamping spring 4 from the clamping position 50 of the clamping spring 4 to the preloaded position 44 of the clamping spring 4. Of course, the reset device 90 may also be provided in the embodiment of FIGS. 1 and 2.

A third embodiment of the wire clamping assembly 1 is described with reference to FIGS. 6 to 8.

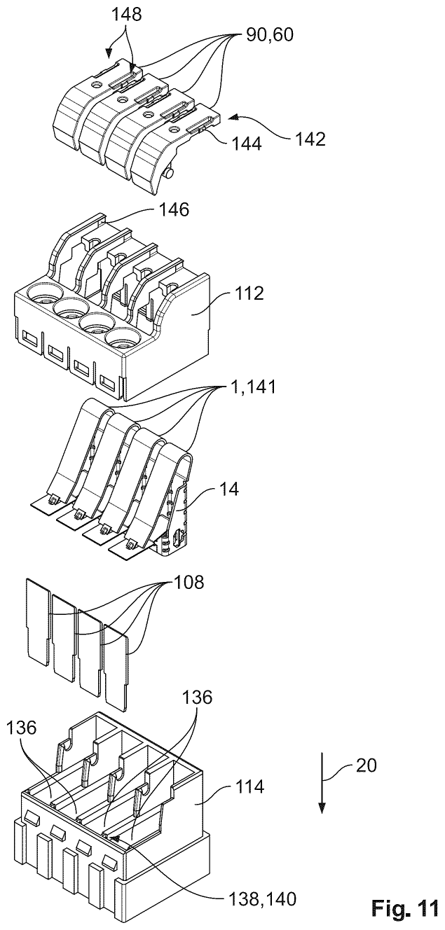

The clamping spring 4 of this embodiment is configured similarly to the embodiment described in FIGS. 1 and 2 and comprises the stationary section 26 and the clamping section 32, which are also connected via an intermediate section 28 and a bent section 30. The clamping spring 4 may be integral with the housing or cage 14, to which the trigger 6 can be mounted, similarly to the embodiment shown in FIGS. 1 and 2, via a slot or shaft. The housing 14 may be smaller than the housing of the embodiment of FIGS. 1 and 2 for better use of space and a different method of assembling, which is further described below with respect to FIG. 11.

An inner housing 114 may surround the housing 14 with the clamping spring 4 and the trigger 6. The inner housing 114 may have a receiving receptacle 116 to receive the housing 14. For example, the stationary section 26 can be inserted into such a receptacle 116 in the insertion direction 20.

The insertion of the conductor 2 pushes the trigger spring 10 out of its position 56 and releases the clamping spring 4 like in the embodiment in FIGS. 1 and 2.

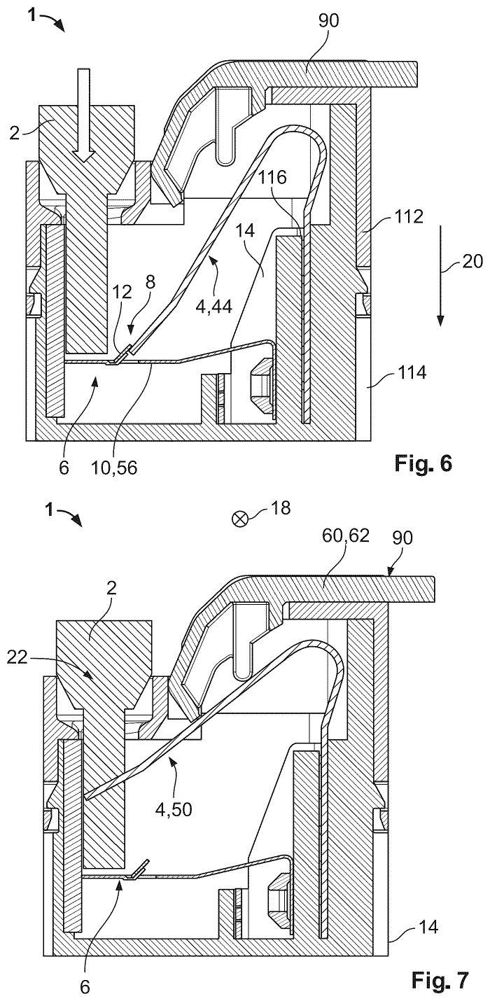

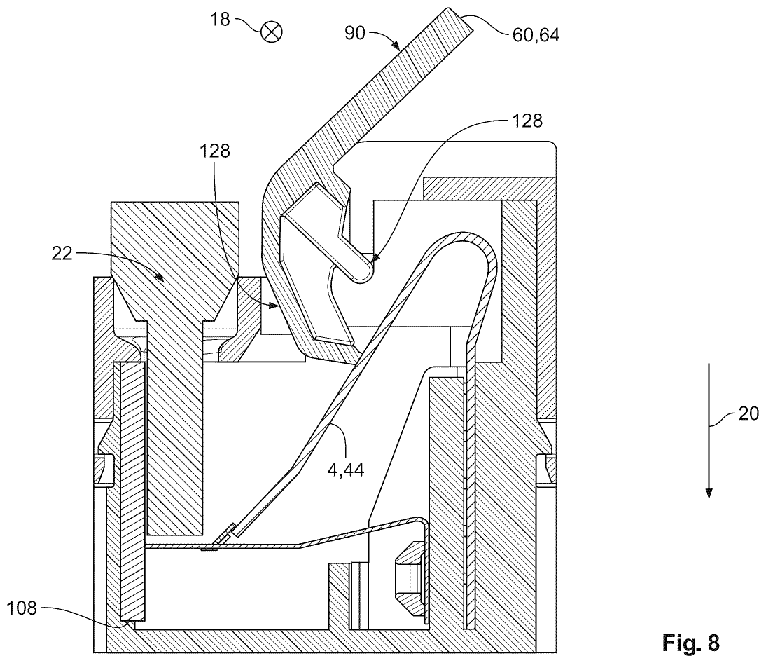

FIG. 7 shows the clamping spring 4 in the clamping position 50, where the clamping spring 4 engages with the conductor 2 to establish an electrical connection. FIG. 8 shows the use of the reset device 90 to reset the clamping spring 4 into the preloaded position 44. The reset device 90 is operated similar to the embodiment shown in FIGS. 3 to 5. The conductor 2 may now be removed against the insertion direction 20.

In any of the above embodiments, the wire clamping assembly 1 may further comprise a contact rail 108 that may consist of a metal strip 110 and extends out of the housing 14 in the insertion direction 20. In another embodiment, the contact rail 108 can be fully inside the housing 14 and not protrude out of the housing 14 in the insertion direction 20, which is beneficial for a compact design of the wire clamping assembly 1.

The wire clamping assembly 1 may, in any embodiment of the above, comprise an outer housing 112 so that the housing 14 becomes an inner housing 114. The outer housing 112 may comprise a plurality of receiving receptacles 116, each receiving receptacle 116 being configured to receive at least one or exactly one wire clamping assembly 1. FIGS. 3 to 5 show a cross-section of the outer housing 112, and in particular a cross-section of the receiving receptacle 116 in which the wire clamping assembly 1 is received. One or more inner housings 114 may be installed in the outer housing 112. The outer housing 112 may partially surround the inner housing 114 about the insertion direction 20.

The lever 60 may be mounted on the outer housing 112 or on the inner housing 114. In one embodiment, part of the lever 60 may be held, e.g. fixed between the inner housing 114 and the outer housing 112, so that the lever 60 can only be moved in a plane parallel to the insertion direction 20 and/or perpendicular to the lateral direction 18. The lever 60 is configured to move, for example with its pushing protrusion 102, the clamping spring 4 from the clamping position 50 of the clamping spring 4 in the direction of the preloaded position 44 of the clamping spring 4, thereby releasing the electrical conductor 2 from its clamping position 50.

In FIG. 3, the trigger component 12 of the latch 8 and the clamping-spring component 82 of the latch 8 are engaged. The latch 8 holds the clamping spring 4 in the preloaded position 44. The lever 60 is fixed in its rest position 62.

If the trigger 6 is actuated by e.g. an electrical conductor 2 which is inserted into the conductor receptacle 24 in the insertion direction 20, the latch 8 is disengaged, thereby releasing the clamping spring 4 from the preloaded position 44 of the clamping spring 4. Such release induces the passage from the state of FIG. 3 to the state of FIG. 4, i.e. the clamping position 50 is assumed.

In FIG. 4, the pivoting element 66 is moved e.g. by the electrical conductor 2 against the action of the trigger spring 10 out of its position 115 at which the latch 8 engages the clamping spring 4. This movement leads to a reaction force 58 generated by the trigger spring 10 and acting, via the pivoting element 66 and the triggering section 25, onto the inserted electrical conductor 2 against the insertion direction 20.

In the clamping position 50, the clamping spring 4 pushes the electrical conductor 2 against the contact rail 108 which may be made of the metal strip 110. A face 118 of the contact rail 108 facing the electrical conductor 2 may have a width 120 that is at least as wide as a width 122 of the clamping spring 4 which in turn may be larger than the diameter of the largest electrical conductor that may be inserted into the assembly 1 according to the assembly's specifications. Furthermore, a length 124 of the contact rail 108 may be greater than a length 126 of the conductor receptacle 24 in the insertion direction 20.

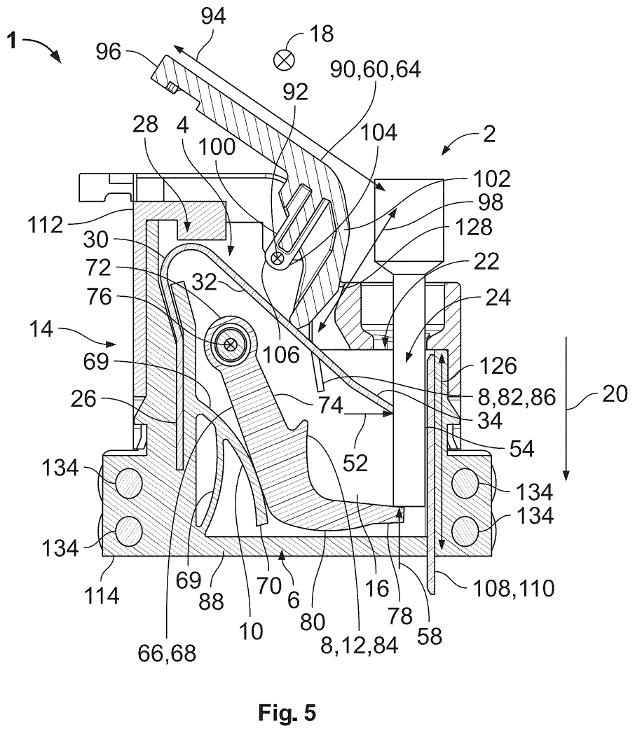

In FIG. 5, the lever 60 has been pivoted from its rest position 62 in the insertion direction 20 to its release position 64 in which, in particular, its pushing protrusion 102 contacts the clamping spring 4 in the clamping position 50. By further pressing the lever 60 against the clamping spring 4, the clamping spring 4 is pushed away from the electrical conductor 2.

The clamping spring 4 is thus moved by the reset device 90 from its clamping position 50 toward its preloaded position 44. The trigger spring 10 exerts a force which, via the triggering section 25, pushes the electrical conductor 2 out of the housing 14 and moves the trigger 6 also towards the preloaded position 44.

The latch 8 may be configured to engage automatically once the trigger 6 and the clamping spring 4 are at a predetermined distance from one another and/or from the preloaded position 44. Thus, upon completed operation of the reset device 90, the wire clamping assembly 1 switches from the state of FIG. 5 to the state of FIG. 3. Once the latch 8 is engaged, the reset device 90 may be returned to its starting position, where the lever is locked or latched to the housing 14. For this, the free end 96 of the lever 60 may be pressed towards the housing 14.

In the any of the above embodiments, the housing 14 may comprise a stopper 128 for the reset device 90, said stopper 128 being stationary relative to the housing 14 and configured to contact the lever 60 after predetermined travel out of its rest position 62 towards the clamping spring 4. The stopper 128 prevents the reset device 90 from exerting force on the clamping spring 4 after the preloaded position 44 is reached and the latch 8 has engaged the clamping spring 4 as in FIG. 3.

Another stopper may limit the movement of the lever 60 from the rest position away from the clamping spring 4.

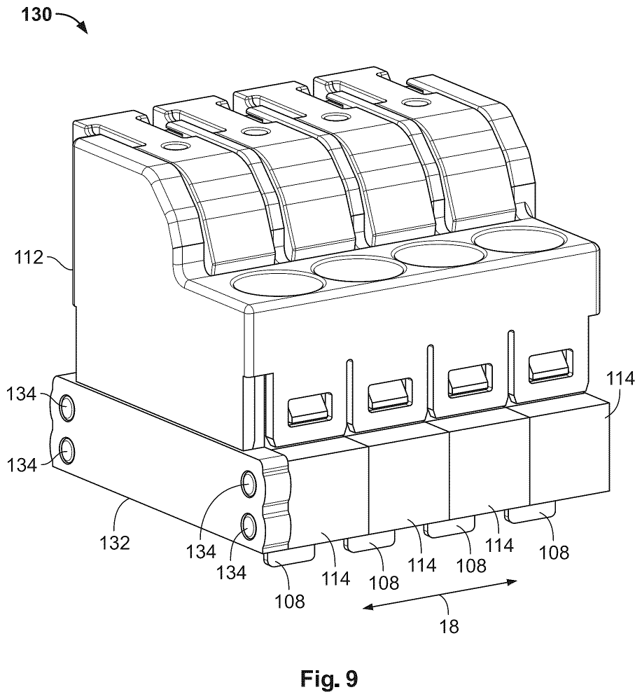

FIG. 9 shows a schematic perspective view of an embodiment of a connector arrangement 130 which comprises a plurality of wire clamping assemblies 1. In this exemplary embodiment, the connector arrangement 130 comprises four wire clamping assemblies 1, one outer housing 112, and a lateral cover 132. The outer housing 112 comprises receiving receptacles 116 that are arranged in a row, wherein each receiving receptacle 116 is configured to receive a wire clamping assembly 1. Each wire clamping assembly 1 may be received in a different receiving receptacle 116. The connector arrangement 130 may be provided in different variants, each variant having an outer housing 112 with a different number and/or geometric arrangement of receiving receptacles 116.

The housing 14 of each wire clamping assembly 1 may be open on one side in the lateral direction 18, so that, when two wire clamping assemblies 1 are arranged next to each other along the lateral direction 18, the housing 14 of one wire clamping assembly 1 forms a lateral wall 16 for both wire clamping assemblies 1. In such a configuration, one of the wire clamping assemblies 1 that are arranged side-by-side remains uncovered and may be covered by the lateral cover 132.

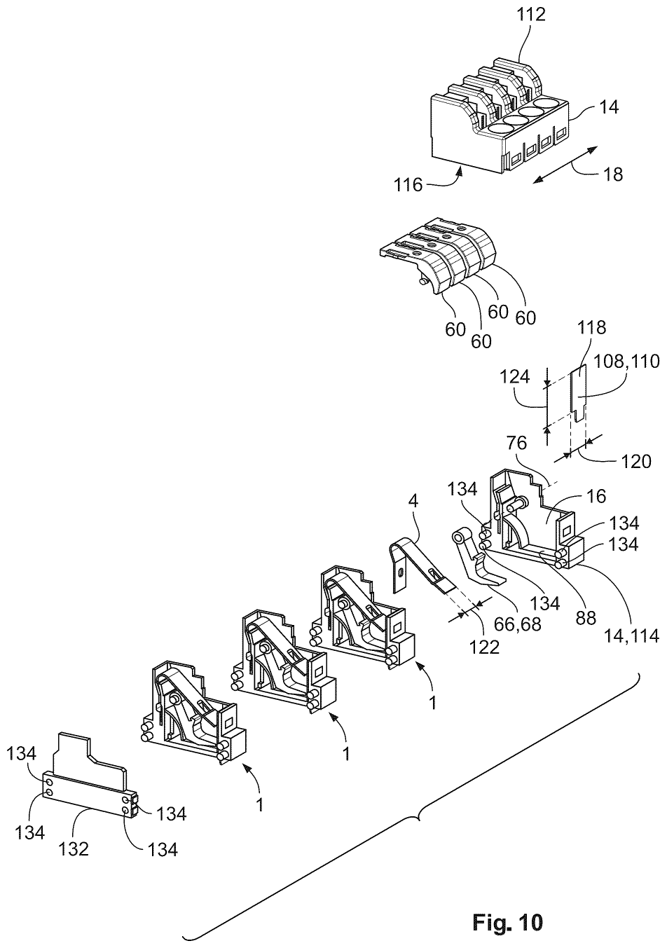

FIG. 10 shows a schematic exploded view of the connector arrangement 130 of FIG. 9. Each wire clamping assembly 1 is provided with its own reset device 90. In such a case, the lever 60 of each reset device 90 may be mounted on the housing 14, in particular the outer housing 112. Each reset device 90 may be operated independently of the other reset devices. In one variant, however, all or some levers 60 may be coupled to each other, so that in effect there is only a single reset device, which operates all wire clamping assemblies 1 of the connector arrangement 130 simultaneously.

The housing 14, in particular the outer housing 112, of each wire clamping assembly 1 may comprise attachment members 134 that are configured to engage complementary attachment members of another housing, so that the housings 14 may be attached to one another, side-by-side in the lateral direction 18. Each housing 14 may comprise a set of complementary attachment members on its two lateral sides that are facing along the lateral direction 18. The lateral cover 132 may comprise attachment members 134 to be attached to the complementary attachment members 134 the housing 14 of one wire clamping assembly 1. One example of attachment members 134 that may be used in such a configuration are dovetail joints.

FIG. 11 shows a schematic exploded view of another embodiment of the connector arrangement 130 with the wire clamping assembly 1 shown in FIGS. 6 to 8.

The inner housing 114 of the shown embodiment is configured as an integral part with multiple slots 136 to receive the wire clamping assembly 1. The contact rails 108 may be inserted in insertion direction 20 into a rail receptacle 138. In this embodiment, the rail receptacle 138 comprises a groove 140 on each lateral wall 16 of the inner housing 114 to receive, guide and hold the contact rail 108.

The wire clamping assembly 1 of the shown embodiment comprising a pre-assembly 141 of the housing 14, the clamping spring 4 and the trigger 6 may be inserted into the inner housing 114 in the same insertion direction 20 as the contact rails 108, in particular in a receiving receptacle 116 (FIGS. 6 to 8) in each slot 136. In this embodiment, the clamping spring 4 and the trigger 6 protrude outside of the housing 14 along a direction perpendicular to the insertion direction 20 and the lateral direction 18. The housing or cage 14 as shown in FIG. 11 comprises two lateral walls that are connected by the stationary section 26 of the clamping spring 4 as well as a wall opposite the stationary section 26.

After insertion of the wire clamping assembly 1, the outer housing 112 may be mounted on top of the inner housing 114 with the contact rails 108 and the wire clamping assembly 1 or pre-assembly 141. The outer housing 112 may also be designed as an integral part complementary to the number of slots 136 in the inner housing 114.

The connector arrangement 130 may then be completed by mounting the reset devices 90 with levers 60, which may be coupled with each other or alternatively, used separately to release individual conductors 2.

FIG. 11 further shows an embodiment of the lever 60 with a lock 142. The protrusions 144 of the lock 142 may be inserted into locking elements 146 of the outer housing 112 to lock the lever 60 into place. The lever 60 may comprise flexible parts 148, which are elastically deformable and may be compressed by a user to release the lever 60 from its locked position.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A wire clamping assembly for automatically clamping an electrical conductor upon insertion of the electrical conductor into the wire clamping assembly, the wire clamping assembly comprising:
a clamping spring;
a trigger; and
a latch;
wherein the latch engages the clamping spring in a preloaded position of the clamping spring;
wherein the trigger is coupled to the latch and configured to disengage the latch when the trigger is operated, thereby releasing the clamping spring, the released clamping spring being configured to clamp the inserted electrical conductor in a clamping position of the clamping spring;
wherein the trigger is configured to be operated by the electrical conductor upon insertion of the electrical conductor into the wire clamping assembly; and
wherein the trigger and the clamping spring are two separate elements.

2. The wire clamping assembly according to claim 1, wherein the trigger comprises a trigger spring and, in the clamping position of the clamping spring, said trigger spring is deflected from its position at which the latch engages the clamping spring.

3. The wire clamping assembly according to claim 1, wherein the trigger comprises a pivoting element and, in the clamping position of the clamping spring, said pivoting element is pivoted out of its position at which the latch engages the clamping spring.

4. The wire clamping assembly according to claim 3, wherein the pivoting element comprises a trigger part.

5. The wire clamping assembly according to claim 1, wherein the latch comprises a trigger component that is stationary relative to the trigger.

6. The wire clamping assembly according to claim 1, wherein the latch comprises a clamping-spring component that is stationary relative to the clamping spring.

7. The wire clamping assembly according to claim 5, wherein the trigger component of the latch and the clamping-spring component of the latch are engaged in a form fit in the preloaded position of the clamping spring.

8. The wire clamping assembly according to claim 1, wherein the wire clamping assembly further comprises a reset device configured to move the clamping spring from the clamping position towards the preloaded position.

9. The wire clamping assembly according to claim 8, wherein the reset device comprises a lever, said lever having a rest position and being pivotable from said rest position to a release position in which it contacts the clamping spring in the clamping position of the clamping spring.

10. The wire clamping assembly according to claim 1, the wire clamping assembly further comprising a housing, wherein the clamping spring, the trigger, and the latch are arranged in the housing and wherein the housing comprises an insertion opening for the insertion of the electrical conductor.

11. The wire clamping assembly according to claim 10, wherein the housing is partly open in a lateral direction and is open on at most one side.

12. The wire clamping assembly according to claim 10, wherein the clamping spring and/or at least part of the trigger is integral with the housing.

13. The wire clamping assembly according to claim 10, wherein the housing comprises a stopper, said stopper being configured to limit movement of the reset device towards the clamping spring.

14. The wire clamping assembly according to claim 1, the wire clamping assembly further comprising a contact rail that extends out of the housing and is configured to contact the electrical conductor in the clamping position.

15. A connector arrangement comprising a plurality of wire clamping assemblies according to claim 1, wherein the connector arrangement further comprises an outer housing, the outer housing comprising a plurality of receiving receptacles, wherein each wire clamping assembly of the plurality of wire clamping assemblies is configured to be received in a receiving receptacle of the plurality of receiving receptacles and is electrically insulated from all other wire clamping assemblies of the plurality of wire clamping assemblies.
